(19) United States
(12) Patent Application Publication
(10) Pub. No.: US 2003/0099923 A1
(43) Pub. Date: May 29, 2003

(54) Combination wheel apparatus

(76) Inventor: Carlos Vintes Pender, Cleveland, OH (US)

Correspondence Address: WATTS, HOFFMANN, FISHER & HEINKE CO., L.P.A., Ste. 1750, 1100 Superior Ave., Cleveland, OH, 44114, US

(21) Appl. No.: 09/990,124

(22) Filed: Nov. 21, 2001

(51) Int. Cl. G09B 19/12; G09B 19/00

(52) U.S. Cl. 434/304; 434/106

(57) ABSTRACT

A method and apparatus for predicting characteristics of a person including a first wheel, a second wheel and connecting means. The first wheel is divided into outer divisions and includes corresponding indicia indicating the months of the year and the days of each month. The first wheel is further divided into twelve inner divisions with indicia indicating the symbols of the Zodiac. The second wheel is divided into twenty-four additional divisions and includes indicia indicating the hours of the day. The second wheel also includes an indicator window within which an operator may view a symbol of the Zodiac. The first and second wheel are arranged so that at least some indicia on the first and second wheel are simultaneously viewable by an operator. A companion guide may be consulted to predict characteristics of a person based on the viewable indicia and other criteria.

### FIELD OF THE INVENTION

The present invention is directed to a method and apparatus for predicting characteristics of a person, and more particularly, the invention is directed to a method and apparatus for predicting characteristics of a person based on their birth date and time of birth using biblical and astrological teachings.

### BACKGROUND ART

Astrology has been known and practiced by man for thousands of years. The study of astrology focuses upon the positions and aspects of the heavenly bodies with a view to predicting their influence on human affairs. Those practicing the science believe characteristics of a certain individual can be determined based upon, among other things, the person's birth date and time of birth.

In modern times, the study of astrology has gained increased popularity with non-practitioners. The study offers educational, commercial and entertainment value to its practitioners and followers. However, the science remains complex and is often difficult to understand. Many reference aids have been published to assist the lay person in analyzing their characteristics. However, performing an accurate astrological analysis remains time consuming and beyond the skill of most lay persons.

Certain prior art devices have been developed for use by lay person. For example, U.S. Pat. No. 3,992,787 to Lynch discloses an astrological comparison apparatus for simple and rapid comparison of the astrological criteria associated with individuals. The device seeks to determine which of the user's qualities of life or aspirations are favorable, and which are unfavorable, at any particular time.

U.S. Pat. No. 5,516,289 to Quigley et al. discloses a second astrological comparison device. The device provides an astrological analysis of the relationship between two people based on specific birth information of each person. The device may be used by two people to determine their compatibility for romance and marriage.

Many other prior art devices and guides only address one aspect of astrology forecasting. Astrology which is only based upon a person's date of birth is commonly referred to as “sun sign” astrology. The following is a brief discussion of the theory of “sun sign” astrology.

The Sun, as the center of our planetary system, is thought to be the most influential heavenly body on a person's astrological horoscope. The Sun is in approximately the same position and distance from Earth on the same calendar day every year. This repetitive pattern is the basis for “sun sign” astrology. The calendar year is divided into twelve periods with each period corresponding to a particular “sun sign” or commonly referred to as Zodiac signs. The twelve Zodiac signs are conventionally segmented into four sign groups; fire, earth, air and water.

A person's “sun sign” may be used to predict general characteristics of a person. Of course, every person born under the “Pieces sun sign”, for example, does not share identical characteristics. It is thought the subtle and not so subtle differences between people of the same “sun sign” are caused by the varying positions of the other planets at their respective times of birth. “Sun sign” astrology does not address these and other subtleties.

These and other known devices focus primarily on the teaching of astrology only. For certain religious followers, the teaching of astrology seems in apparent conflict with their particular faith. A Christian, for example, may feel compelled to study astrology, but reject the study due to teachings of their particular church. Others may find certain Bible teachings in conflict with astrology. Still others may see astrology in conflict with traditional sciences.

Therefore, there exists a need in the art for a device that incorporates the study of astrology beyond conventional “sun sign” theory while including the teaching of the Bible and traditional science.

### SUMMARY OF THE INVENTION

The present invention is directed to a method and apparatus for predicting characteristics of a person using biblical and astrological teachings. The invention allows an operator to control a first and second wheel to determine criteria about a subject person based on their birth date and time of birth.

In one embodiment of the present invention, an apparatus includes a first wheel, a second wheel and connecting means for permitting rotational movement of the second wheel with respect to the first wheel.

A first wheel is divided into twelve outer divisions and includes indicia indicating the months of the year disposed in each outer division around an annular outer portion of the wheel. Indicia indicated the days of each month are disposed in each outer division. The first wheel is also divided into twelve inner divisions and includes indicia indicating the symbols of the Zodiac disposed in each inner division around an annular inner portion of the wheel. The inner divisions are separated by dividing means.

A second wheel is divided into twenty-four additional divisions and includes indicia indicating hours of the day disposed in each additional division around an annular portion of the second wheel. Indicia indicated time periods of each hour are disposed in each additional division. The second wheel also includes an indicator window wherein an operator may view a symbol of the Zodiac on the first wheel that is exposed within the indicator window.

Connecting means are included for permitting rotational movement of the second wheel with respect to the first wheel for aligning a day on the first wheel with a time on the second wheel. The first and second wheels are arranged so that at least some indicia on the first wheel and at least some indicia on the second wheel are simultaneously viewable by an operator.

The first wheel may include four minor divisions and indicia indicating four time periods of the year disposed in each division around an annular outer portion of the wheel. The first wheel may include four minor divisions and indicia indicating the “four rivers of mankind” disposed in each division around an annular outer portion of the wheel. The first wheel may comprise twelve minor divisions and indicia indicating the twelve “Disciples of Jesus Christ” disposed in each division around an annular outer portion of the wheel.

The Zodiac symbol indicating indicia may be disposed adjacent corresponding indicia indicating the twelve “sons of Jacob” wherein one Zodiac symbol indicating indicia corresponds with one “son of Jacob” indicating indicia. The Zodiac symbol indicating indicia may be used by an operator to determine a “rising sign” of a subject person.

A method of operating an apparatus, for predicting characteristics of a subject person, includes the steps of locating a subject person's birth date on a first wheel, locating a subject person's time of birth on a second wheel, aligning the time of birth on the second wheel with the birth date on the first wheel, and observing a symbol of the Zodiac on the first wheel that is exposed within the indicator window.

A method of the invention may include the step of consulting a companion guide to determine characteristics of a subject person based on the combination of the subject person's “rising sun” sign and their astrological Zodiac sign, when the symbol of the Zodiac on the first wheel that is exposed within the indicator window represents a “rising sun” sign of a subject person.

The method may include the step of consulting a companion guide to determine characteristics of a subject person based on their birth date in relation to corresponding indicia indicating the “four rivers of mankind” disposed around an annular outer portion of the first wheel.

The method may include the step of consulting a companion guide to determine characteristics of a subject person based on their astrological Zodiac sign.

These and other objects, advantages and features of the invention will become better understood by review of the accompanying description of the best mode for carrying out the invention which is described in conjunction with the accompany drawings.

### BRIEF DESCRIPTION OF THE DRAWINGS

FIG. 1 is a plan view of an assembled apparatus constructed in accordance with one embodiment of the present invention;

FIG. 2 is a plan view of a first wheel of the apparatus illustrated in FIG. 1;

FIG. 3 is a plan view of a second wheel of the apparatus illustrated in FIG. 1;

FIG. 4 is an exploded end view of the apparatus illustrated in FIG. 1, showing the first wheel, the second wheel and a connecting means;

FIG. 5 is a plan view of the assembled apparatus illustrated in FIG. 1, showing the second wheel rotated with respect to the first wheel to an exemplary position;

FIG. 6 is an enlarged fragmentary view of part of the assembled apparatus illustrated in FIG. 1, showing the second wheel rotated with respect to the first wheel to the exemplary position illustrated in FIG. 5;

FIG. 7 is a plan view of the assembled apparatus illustrated in FIG. 1, showing the second wheel rotated with respect to the first wheel to a second exemplary position; and

FIG. 8 is an enlarged fragmentary view of part of the assembled apparatus illustrated in FIG. 1, showing the second wheel rotated with respect to the first wheel to the second exemplary position illustrated in FIG. 7.

### BEST MODE FOR CARRYING OUT THE INVENTION

The disclosed exemplary embodiment of the present invention addresses the need for a device that incorporates the study of astrology beyond conventional “sun sign” study while including the teaching of the Bible and traditional science. The apparatus offers assorted educational and entertainment benefits to the operator and observer by predicting characteristics of a subject person.

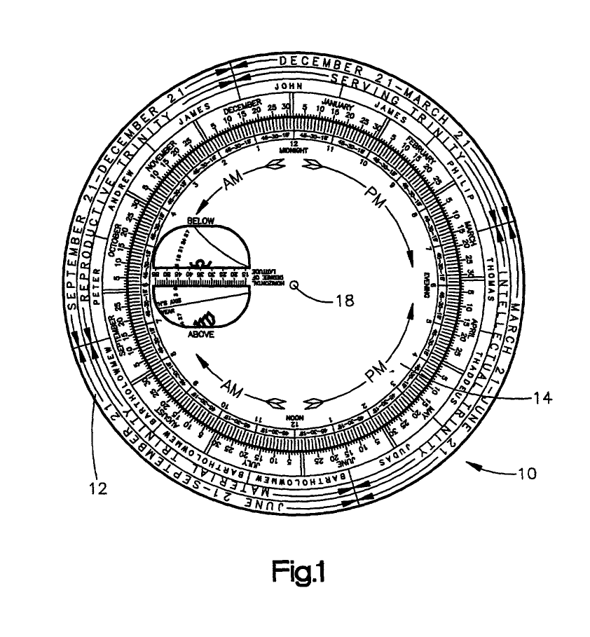

Referring now to the drawings, a plan view of an assembled apparatus 10 constructed in accordance with one embodiment of the present invention is illustrated in FIG. 1. The apparatus 10 as illustrated includes a first wheel 12, a second wheel 14 and connecting means 18. The connecting means 18 permit rotational movement of the second wheel 14 with respect to the first wheel 12.

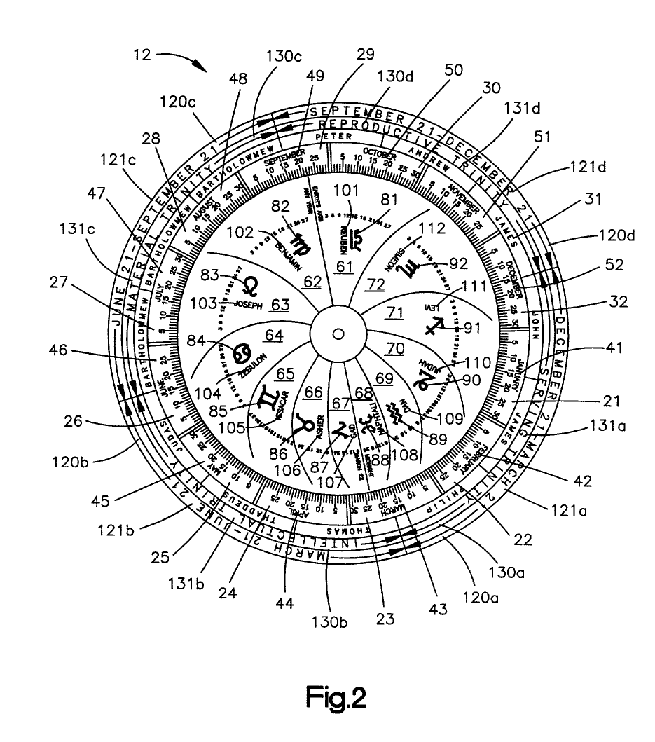

Referring to FIG. 2, a plan view of the first wheel 12 of the apparatus shown in FIG. 1 is illustrated. The first wheel 12 is divided into twelve outer divisions 21, 22, 23 . . . 32. As illustrated, the twelve outer divisions 21, 22, 23 . . . 32 are similar in size and are disposed around an annular outer portion of the wheel 12. Indicia 41, 42, 43 . . . 52 indicating the months of the year are disposed in each outer division 21, 22, 23 . . . 32. For example, one outer division 24 of the first wheel 12 includes the indicia “April” 44. Indicia indicated the calendar days of each month are disposed in each outer division 21, 22, 23 . . . 32. As illustrated, the indicia indicated the calendar days of each month are numeric.

The first wheel 12 is divided into twelve inner divisions 61, 62, 63 . . . 72. As illustrated, the twelve inner divisions 61, 62, 63 . . . 72 are dissimilar in size and are disposed around an annular inner portion of the wheel 12. Indicia 81, 82, 83 . . . 92 indicating the symbols of the Zodiac are disposed in each inner division 61, 62, 63 . . . 72. The symbols are believed to originate from the Greek alphabet and are commonly used in association with the twelve signs of the Zodiac. For example, one inner division 64 of the first wheel 12 includes the traditional symbol for the Zodiac Sign “Cancer” 84. The inner divisions 61, 62, 63 . . . 72 are separated by dividing means. As illustrated, the inner divisions 61, 62, 63 . . . 72 are separated by arcuate lines.

Still referring to FIG. 2, indicia 101, 102, 103 . . . 112 indicated the twelve “sons of Jacob” are disposed in each inner division 61, 62, 63 . . . 72. The twelve “sons of Jacob” have been equated to the “12 steps of Jacob's ladder” by many religious scholars, as well as the twelve “tribes of Israel.”

As illustrated, the indicia 101, 102, 103 . . . 112 indicated the twelve “sons of Jacob” are disposed adjacent corresponding indicia indicating the twelve symbols 81, 82, 83 . . . 92 of the Zodiac. As illustrated, one Zodiac symbol indicating indicia corresponds with one “son of Jacob” indicating indicia. For example, one inner division 64 of the first wheel 12 includes the name of Zeb 104, one of the twelve “sons of Jacob.”

The first wheel as illustrated in FIG. 2 includes four minor divisions 120a, 120b, 120c, 120d disposed around an annular most outer portion of the wheel 12. Indicia 121a, 121b, 121c, 121d indicating four time periods of the year are disposed in each four minor division 120a, 120b, 120c, 120d. The four time periods equate to the conventional four seasons of the year.

As illustrated, the first minor division 120a equates to the season of Winter and corresponds to period from December 21 to March 21, or from the Winter Solstice to the Spring Meridian, or Equinox. The second minor division 120b equates to the season of Spring and corresponds to period from March 21 to June 21, or from the Spring Equinox to the Summer Solstice. The third minor division 120c equates to the season of Summer and corresponds to period from June 21 to September 21, or from the Summer Solstice to the Fall Equinox. As illustrated, the fourth minor division 120d equates to the season of Autumn and corresponds to period from September 21 to December 21, or from the Fall Equinox to the Winter Solstice.

Again referring to FIG. 2, the first wheel 12 includes four additional minor divisions 130a, 130b, 130c, 130d disposed around an annular portion of the wheel 12. As illustrated, the four additional minor divisions 130a, 130b, 130c, 130d include indicia 131a, 131b, 131c, 131d indicating the “four rivers of mankind.” The four rivers of mankind are discussed in the Bible at Genesis Chapter 2:10-14. As illustrated in FIG. 2, four names, i.e., Serving Trinity 131a, Intellectual Trinity 131b, Material Trinity 131c and Reproductive Trinity 131d have been selected to represent the “four rivers of mankind.”

The first wheel 12 includes twelve additional minor divisions 140a, 140b, 140c. . . 140l disposed around an annular portion of the wheel 12. As illustrated, the twelve additional minor divisions 140a, 140b, 140c. . . 140l include indicia 141a, 141b, 141 c. . . 141l indicating the twelve “Disciples of Jesus Christ.” As illustrated in FIG. 2, twelve names, i.e., John 141a, James 141b, Philip 141c, Thomas 141d, Thaddeus 141e, Judas 141f, Matthew 141g, Simon 141h, Bartholomew 141i, Peter 141j, Andrew 141k and James 141l have been selected to represent the twelve “Disciples of Jesus Christ.”

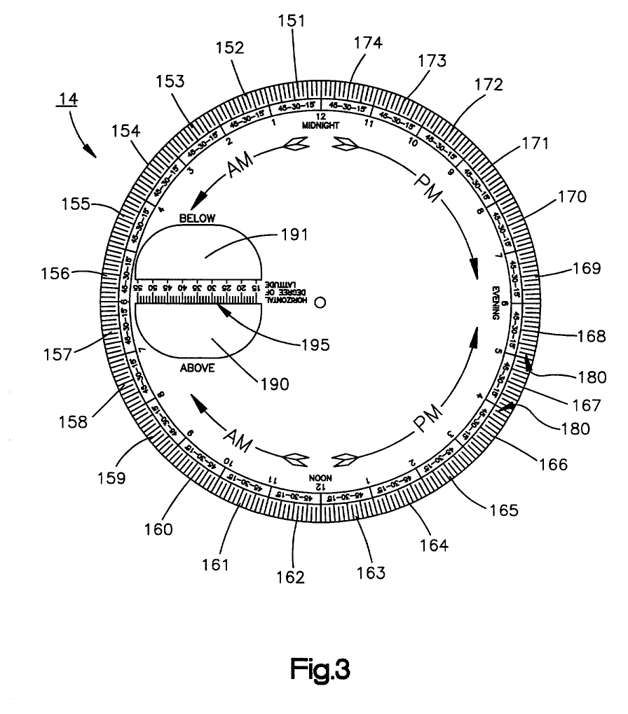

Referring now to FIG. 3, a plan view of a second wheel 14 of the apparatus is illustrated. The second wheel 14 is divided into twenty-four divisions 151, 152, 153 . . . 174. The divisions are similar in size and are disposed around an outermost annular portion of the second wheel 14. Indicia indicating hours of the day are disposed in each division. As illustrated, numerical indicia indicate the hours within a twenty-four hour period. Further indicia 180 indicated time periods of each hour are disposed in each division. As illustrated, each of the twenty-four divisions 151, 152, 153 . . . 174 is divided into twelve segments, each segment five minutes in duration.

The second wheel 14 includes an indicator window 190. An operator of the device 10 may view a symbol of the Zodiac on the first wheel 12 that is exposed within the indicator window 190. As the second wheel 14 rotates with respect to the first wheel 12, the symbol within the indicator window 190 changes. An alternative indicator window 191 is included.

An indicator scale 195 is included to determine the degree of latitude in which the Sun's ray are striking the Earth's horizon at the moment of the birth of the subject person.

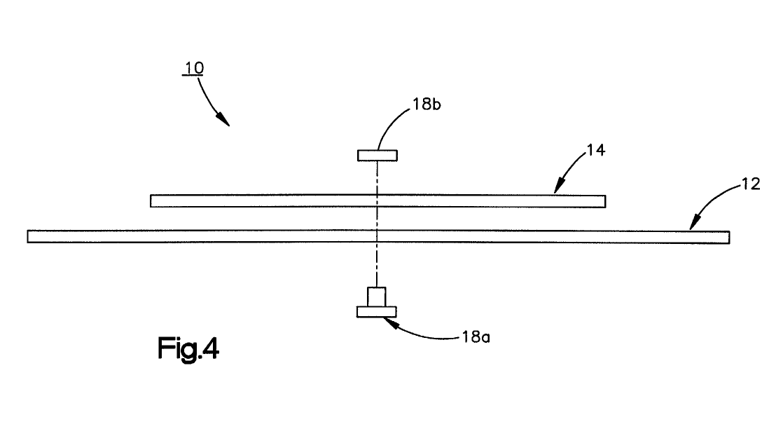

FIG. 4 is an exploded end view of the apparatus illustrated in FIG. 1, showing the first wheel 12, the second wheel 14 and a connecting means 186. The connecting means 186 permits rotational movement of the second wheel 14 with respect to the first wheel 12 for aligning a day on the first wheel 12 with a time on the second wheel 14. As illustrated, the connecting means 186 is a two-piece set of inserting members.

Method of Operation of the Invention

An exemplary method of operation of the device will now be discussed. A method of operating an apparatus, for predicting characteristics of a subject person, includes several steps. The operator of the device must first determine, or recall from memory, certain information about a subject person. For purposes of example only, in a first example the subject person was born at 4:45 am on August 25^{th}.

As discussed, the subject person, and every person, has a “sun sign” based on their day of birth. In this example, the subject person is born August 25^{th} and has the Zodiac “sun sign” of Virgo. As discussed, each sign has a particular elements associated therewith, i.e., the elements of earth, air, water and fire. Conventionally, Virgo is known as an earth sign. Table 1 below details the twelve Zodiac signs, the sign types and their respective calendar period.

TABLE 1
Twelve Zodiac “Sun Signs”

| Sign | Sign Type | Start Date | End Date |
|---|---|---|---|
| Aries | Fire | March 21 | April 19 |
| Taurus | Earth | April 20 | May 20 |
| Gemini | Air | May 21 | June 21 |
| Cancer | Water | June 22 | July 22 |
| Leo | Fire | July 23 | August 22 |
| Virgo | Earth | August 23 | September 22 |
| Libra | Air | September 23 | October 23 |
| Scorpio | Water | October 24 | November 21 |
| Sagittarius | Fire | November 22 | December 21 |
| Capricorn | Earth | December 22 | January 19 |
| Aquarius | Air | January 20 | February 18 |
| Pisces | Water | February 19 | March 20 |

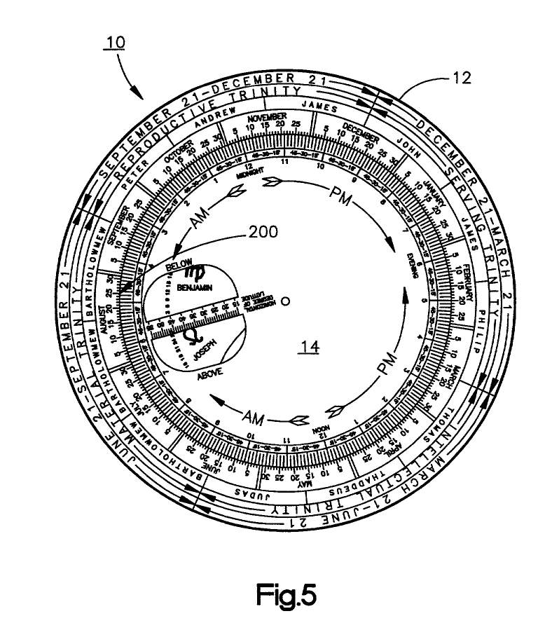

The first step of an exemplary method in accordance with one embodiment of the present invention includes locating a subject person's birth date on the first wheel 12. The second method step includes locating a subject person's time of birth on a second wheel 14. A third method step includes aligning the time of birth of the subject person on the second wheel 14 with the birth date of the subject person on the first wheel 12. A apparatus 10 is illustrated in FIG. 5 with the second wheel 14 oriented rotationally with the first wheel 12 so that the time of birth of the subject person aligns with the birth date of the subject person at a common alignment point 200.

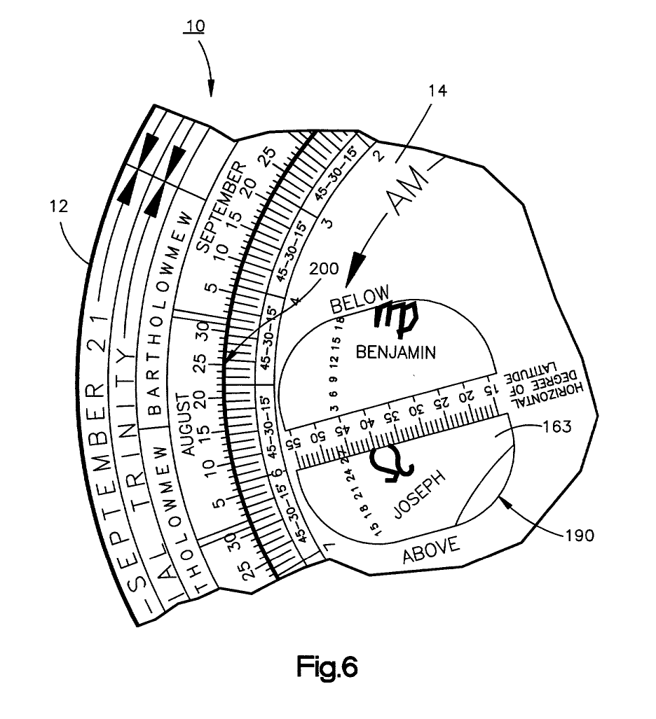

Referring now to FIG. 6, an enlarged fragmentary view of part of the assembled apparatus 10 is illustrated showing the second wheel 14 rotated with respect to the first wheel 12 to the exemplary position illustrated in FIG. 5. The next method step includes viewing the indicia in the indicator window 190. As illustrated, the indicator window 190 reveals inner division 63, indicia 83 indicating a symbol of the Zodiac sign “Leo” and indicia 103 indicating a “son of Jacob.” As illustrated, the indicia 103 indicates “Joseph”, the eleventh of the twelve “sons of Jacob.” Joseph and his brothers, discussed in the Bible at Gen. 27-49, are believed by Christian scholars to have formed the origin of the “twelve tribes of Israel.”

A method may include the operator viewing the symbol of the Zodiac on the first wheel that is exposed within the indicator window 190 and the subsequently determining a “rising sign” of a subject person. As illustrated in the example shown in FIG. 6, the subject person has a “rising sign” of “Leo.”

It will be apparent to others with ordinary skill in the art that a subject person's “sun sign” will not necessarily equate to their “rising sign.” As best shown in FIG. 2, the arcuate dividing lines that separate the inner divisions 61, 62, 63 . . . 72 do not equate to the calendar segments listed in Table 1. However, the “rising signs” are also associated to segments identified as fire, earth, air and water in the same manner as the “sun signs.” For example, the subject person born at 4:45 am on August 25 has a earth “sun sign”, i.e., Virgo, and a fire “rising sign”, i.e., Leo.

A method may include the step of consulting a companion guide to determine characteristics of a subject person based on the person's “sun sign” and the combination of the subject person's “rising sign” and their Zodiac “sun sign.”

Supplementary written materials provided with the apparatus of the present invention will preferably include a companion guide which contains sections to aid the operator of the device. Sections in the guide may aid the operator in interpreting the indicia corresponding to a subject person's birth date and combination of birth date and birth time. Certain sections may provide information about “The Four Rivers on Mankind”, “sun signs” as related to biblical teachings, and an interpretation of a person's combined “sun sign” and “rising sign.” One such companion guide is entitled “Christian Rising Finder” by Carlos Vintes Pender, United States copyright # TXU773-509.

As illustrated in FIG. 6, the operator may determine additional information from the apparatus 10 in its exemplary alignment. A method may include the step of consulting a companion guide to determine characteristics of a subject person based on their birth date in relation to corresponding indicia 131c indicating one of “four rivers of mankind” disposed around the annular outer portion of the first wheel 12. The subject person, born on August 25, is born under the period of the disciple Bartholomew and the Material Trinity 131c “river of mankind.”

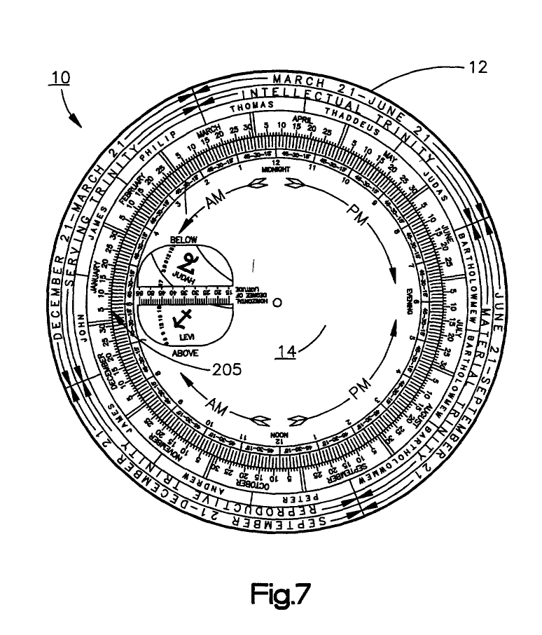

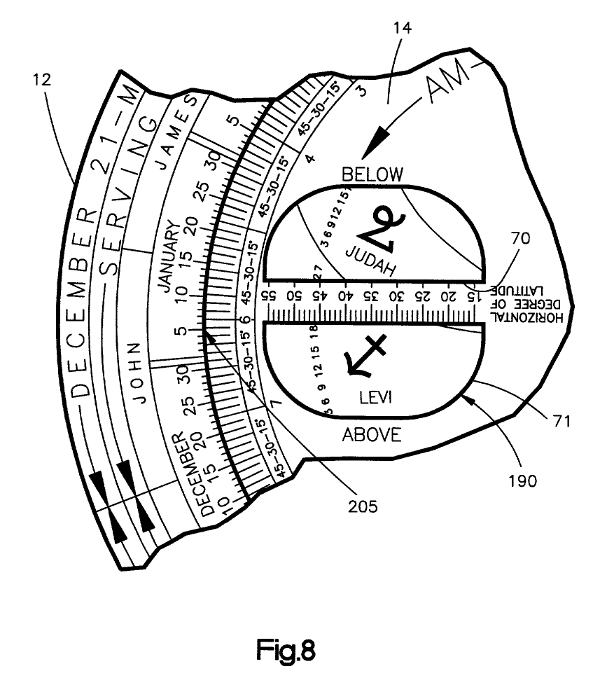

Referring now to FIG. 7, a plan view of the assembled apparatus 10 is illustrated showing the second wheel 14 rotated with respect to the first wheel 12 to a second exemplary position. FIG. 8 is an enlarged fragmentary view of part of the assembled apparatus 10 illustrated in FIG. 7.

In this second example, the subject person was born on January 5^{th} at 6:15 am. Using the methods steps previously discussed, it can be determined that the subject person was born under the “Serving Trinity” 131a “river of mankind” and the period of the discipline John.

The indicator window 190 reveals parts of two different inner divisions 70, 71. Specifically, the indicator window 190 reveals a large portion of one inner division 71 and a small portion of inner division 70. In this and other similar cases, an operator may assume a subject's “rising sign” is found in the larger 71 of the two revealed inner divisions. Other alternative methods may also be used, such as a process of elimination by one with ordinary skill in the art asks particular questions of the subject person to ascertain the subject person's “rising sign.” As illustrated, the indicator window 190 reveals inner division 71 and indicia 91 indicating a symbol of the Zodiac sign “Sagittarius” and indicia 111 indicating Levi, a “son of Jacob.”

Although the present invention has been described with a degree of particularity, it is the intent of the Applicant that the invention include all modifications and alterations apparent to those skilled in the art from the above detailed description and within the spirit or scope of the appended claims.

What is claimed is:

1. An apparatus, for predicting characteristics of a subject person, comprising:
a first wheel, said wheel being divided into twelve outer divisions, indicia indicating the months of the year being disposed in each outer division around an annular outer portion of said wheel, indicia indicated the days of each month being disposed in each outer division, and said wheel being divided into twelve inner divisions, indicia indicating the symbols of the Zodiac being disposed in each inner division around an annular inner portion of said wheel, wherein said inner divisions are separated by dividing means;
a second wheel, said second wheel being divided into twenty-four additional divisions, indicia indicating hours of the day being disposed in each additional division around an annular portion of said second wheel, indicia indicated time periods of each hour being disposed in each additional division, and said second wheel comprising an indicator window, wherein an operator may view a symbol of the Zodiac on the first wheel that is exposed within said indicator window; and
connecting means for permitting rotational movement of the second wheel with respect to the first wheel for aligning a day on said first wheel with a time on said second wheel;
wherein said first and second wheels are arranged so that at least some indicia on said first wheel and at least some indicia on said second wheel are simultaneously viewable by an operator.

2. The apparatus of claim 1 wherein said first wheel comprises four minor divisions, indicia indicating four time periods of the year being disposed in each division around an annular outer portion of said wheel.

3. The apparatus of claim 1 wherein said first wheel comprises four minor divisions, indicia indicating the “four rivers of mankind” being disposed in each division around an annular outer portion of said wheel.

4. The apparatus of claim 1 wherein said first wheel comprises twelve minor divisions, indicia indicating the twelve “Disciples of Jesus Christ” being disposed in each division around an annular outer portion of said wheel.

5. The apparatus of claim 1 wherein said Zodiac symbol indicating indicia is disposed adjacent corresponding indicia indicating the twelve “sons of Jacob” wherein one Zodiac symbol indicating indicia corresponds with one “son of Jacob” indicating indicia.

6. The apparatus of claim 1 wherein said time period indicating indicia are disposed such that each hour is divided into 12 divisions, wherein each division is five minutes in duration.

7. The apparatus of claim 1 wherein each said Zodiac symbol indicating indicia may be used by an operator to determine a “rising sign” of a subject person.

8. A method of operating an apparatus, for predicting characteristics of a subject person, comprising the steps of:
a) locating a subject person's birth date on a first wheel, said wheel being divided into twelve outer divisions, indicia indicating the months of the year being disposed in each outer division around an annular outer portion of said wheel, indicia indicated the days of each month being disposed in each outer division, and said wheel being divided into twelve inner divisions, indicia indicating the symbols of the Zodiac being disposed in each inner division around an annular inner portion of said wheel, wherein said inner divisions are separated by dividing means;
b) locating a subject person's time of birth on a second wheel, said second wheel being divided into twenty-four additional divisions, indicia indicating hours of the day being disposed in each additional division around an annular portion of said second wheel, indicia indicated time periods of each hour being disposed in each additional division, and said second wheel comprising an indicator window, wherein an operator may view a symbol of the Zodiac on the first wheel that is exposed within said indicator window;
c) aligning said time of birth on said second wheel with said birth date on said first wheel; and
d) observing a symbol of the Zodiac on the first wheel that is exposed within said indicator window.

9. The method of claim 8 wherein said symbol of the Zodiac on the first wheel that is exposed within said indicator window represents a “rising sun” sign of a subject person.

10. The method of claim 8 wherein said symbol of the Zodiac on the first wheel that is exposed within said indicator window represents a “rising sun” sign of a subject person, and comprising the step of consulting a companion guide to determine characteristics of a subject person based on the combination of the subject person's said “rising sun” sign and their astrological Zodiac sign.

11. The method of claim 8 comprising the step of consulting a companion guide to determine characteristics of a subject person based on their birth date in relation to corresponding indicia indicating the “four rivers of mankind” disposed around an annular outer portion of said first wheel.

12. The method of claim 8 comprising the step of consulting a companion guide to determine characteristics of a subject person based on their astrological Zodiac sign.
